(19) United States
(12) Patent Application Publication
(10) Pub. No.: US 2024/0110107 A1
(43) Pub. Date: Apr. 4, 2024

(54) CO-PROCESSING OF POLYMER WASTE-BASED MATERIAL FOR JET FUEL PRODUCTION

(71) Applicant: Neste Oyj, Espoo (FI)

(72) Inventors: Kati SANDBERG, Porvoo (FI); Pirjo SAIKKONEN, Porvoo (FI); Ville PAASIKALLIO, Porvoo (FI); Andrea PÉREZ NEBREDA, Porvoo (FI)

(73) Assignee: Neste Oyj, Espoo (FI)

(21) Appl. No.: 18/257,764

(22) PCT Filed: Dec. 30, 2021
(86) PCT No.: PCT/FI2021/050917

§ 371 Date: Jun. 15, 2023

(30) Foreign Application Priority Data
Dec. 30, 2020 (FI) 20206383

(51) Int. Cl. C10G 1/10; C10G 1/00; C10G 45/08

(52) U.S. Cl. CPC C10G 1/10; C10G 1/002; C10G 45/08; C10G 2300/1003; C10G 2300/301; C10G 2400/08

(57) ABSTRACT

Provided is a method for upgrading polymer waste-based material. The method includes providing a polymer waste-based feedstock, providing a crude oil-derived feedstock, blending the polymer waste-based feedstock, the crude oil-derived feedstock, and optionally a further feed material, to provide a feed mixture, hydrotreating the feed mixture at hydrodesulphurisation conditions to provide a hydrotreated material boiling in the middle distillate range, and recovering at least a jet fuel component from the hydrotreated material.

### TECHNICAL FIELD

### Background of the Invention

The purification and conversion of polymer waste-based material, such as liquefied waste plastic (e.g. waste plastic pyrolysis oil; WPPO), to yield more valuable (pure) substances and the conversion of waste plastic pyrolysis oil (WPPO) into more valuable material have been studied for several years. Polymer waste refers to waste material comprising polymers, such as plastic waste, end-life tires, and liquid polymer materials. In practice, polymer waste is usually processed in the form of polymer waste-based oils (also referred to as liquefied polymer waste), such as liquefied waste plastics (LWP) or liquefied end-life tires.

Polymer waste-based oils may be produced by a thermal degradation method, such as hydrothermal liquefaction (HTL) or pyrolysis of polymer waste. Depending on the source of the polymer waste, polymer waste has variable levels of impurities. Typical impurity components are chlorine, nitrogen, sulphur and oxygen of which corrosive chlorine is particularly problematic for refinery/petrochemical processes. These impurities are also common in post-consumer waste plastics (recycled consumer plastics) that have been identified as the most potential large scale source for polymer waste besides end-life tires. Similarly, bromine-containing impurities may be contained mainly in industry-derived polymer waste (e.g. originating from flame retardants). Sulphur is a common impurity in polymer waste-based oil (or polymer waste-based material) derived from end-life tires, i.e. end-life tires pyrolysis oil (ELTPO). Moreover, polymer waste-based oils produced by a pyrolysis process or hydrothermal liquefaction usually contain significant amounts of olefins and aromatics, depending on the actual production process, each of which may lead to problems in some downstream processes, such as polymerisation (or coking) at elevated temperatures.

Accordingly, the prior art mainly employs polymer waste-based material as a low grade fuel and techniques of upgrading polymer waste-based material to more valuable substances are rare, require complicated processes and/or result in degradation of product properties as compared to conventional products, such as products made from crude oil fractions.

No matter whether the polymer waste-based material is merely subjected to fractionation or is forwarded to a typical petrochemical conversion process (e.g. steam cracking), the polymer waste-based material needs to meet the impurity levels for these processes so as to avoid deterioration of the facility, such as corrosion of reactors or catalyst poisoning.

In addition to refining, chemical recycling of polymer waste back to polymers (or to monomers) has caught significant interest in the petrochemical industry during the last years. Using polymer waste-based material as feedstock for crackers (such as catalytic crackers, hydrocrackers or steam crackers) is a promising method to recycle polymers because of the existing infrastructure. However, the potential of polymer waste-based material as cracker feedstock depends on its quality and thus methods for purifying the polymer waste-based material and/or modifying the cracking procedures have been proposed in order to handle the varying impurity contents of polymer waste.

Further, is has been considered to recycle polymer waste-based material into fuel. However, the challenges of the polymer waste-based feedstock (polymer waste-based material) resulted in rather few attempts in this direction.

For example, WO 2018/10443 A1 discloses a steam cracking process comprising pre-treatment of a mainly paraffinic hydrocarbon feed, such as hydrowax, hydrotreated vacuum gas oil, pyrolysis oil from waste plastics, gasoil or slackwax. Pre-treatment is carried out using a solvent extraction so as to reduce fouling components, such as polycyclic aromatics and resins.

JP 2005-272759 A1 discloses mixing a light polymer waste-based oil fraction and a petroleum fraction in a petrochemical process and subjecting the mixture to e.g. hydrocracking and fractionation.

Han et al, Fuel Processing Technology 159 (2017), pages 328-339 discloses co-hydrotreatment (hydrocracking) of vegetable oil and end-life tires pyrolysis oil (ELTPO) over a Co—Mo-based catalyst, aiming at producing fuels.

US 2016/0264874 A1 discloses a process for upgrading waste plastics, comprising a pyrolysis step, a hydroprocessing step, a polishing step and a stream cracking step in this order.

U.S. Pat. No. 9,920,262 B discloses fractionation of polymer waste-based oil into a light and a heavy fraction and removing sulphur and/or nitrogen from the heavy fraction by catalytic oxidation, in order to make the heavy fraction fit for use as a heavy fuel oil.

Kawanishi, T., Shiratori, N., Wakao, H., Sugiyama, E., Ibe, H., Shioya, M., & Abe, T., “Upgrading of Light Thermal Cracking Oil Derived from Waste Plastics in Oil Refinery. Feedstock recycling of plastics.” Universitätsverlag Karlsruhe, Karlsruhe (2005), p. 43-50 discloses hydrotreating a blend of petroleum fractions and light thermal cracking oil from waste plastics to avoid fouling of a heat exchanger preceding the hydrotreater.

### SUMMARY OF INVENTION

The above prior art approaches employ complicated purification procedures, of which extraction techniques may result in significant amounts of contaminated extraction material, or provide a material which is still not fully suitable for further use or processing and which leads to fouling and reduced service life of the processing equipment. There is still need for a more sustainable process allowing recycling varying amounts of polymer waste-based material while producing low amounts of waste products.

The present invention was made in view of the above-mentioned problems and it is an object of the present invention to provide an improved method for upgrading polymer waste-based material, in particular a more sustainable method of producing valuable products from polymer waste-based material. Specifically, it is an object of the present invention to produce a jet fuel containing upgraded polymer waste-based material without deterioration of jet fuel characteristics and even exceeding the characteristics of jet fuel not containing the upgraded polymer waste-based material.

This problem of providing an improved method for upgrading polymer waste-based material is solved by a method of claim 1. This and other objects of the invention are achieved by the subject-matters set forth in the claims and in the items below.

In brief, the present invention relates to one or more of the following items:
1. A method for upgrading polymer waste-based material, the method comprising:
   providing a polymer waste-based feedstock comprising liquefied waste plastic (LWP) or a fraction thereof and/or end-life-tires pyrolysis oil (ELTPO) or a fraction thereof (step A),
   providing a crude oil-derived feedstock (step B),
   blending the polymer waste-based feedstock, the crude oil-derived feedstock, and optionally a further feed material, to provide a feed mixture (step C), wherein the blending in step (C) is carried out such that the feed mixture contains at least 0.5 wt.-% of the polymer waste-based feedstock,
   hydrotreating the feed mixture at hydrodesulphurisation conditions to provide a hydrotreated material (step D),
   distilling the hydrotreated material (step E) to obtain at least a jet fuel component having a final boiling point (FBP) in the range of from 190° C. to 300° C. and a residue fraction.
2. The method according to item 1, wherein the crude oil-derived feedstock is a middle distillate range feedstock.
3. The method according to item 1 or 2, wherein the crude oil-derived feedstock is at least one crude oil fraction selected from a kerosene fraction, a light gas oil fraction and a gas oil fraction.
4. The method according to any one of the preceding items, wherein the polymer waste-based feedstock provided in step (A) is or comprises a polymer waste-based oil or a fraction thereof, preferably a fraction of polymer waste-based oil.
5. The method according to any one of the preceding items, wherein the polymer waste-based feedstock provided in step (A) is liquefied waste plastics (LWP) or a fraction thereof, in particular waste plastics pyrolysis oil (WPPO) or a fraction thereof, or end-life tires pyrolysis oil (ELTPO) or a fraction thereof.
6. The method according to any one of the preceding items, wherein the polymer waste-based feedstock provided in step (A) is or comprises a pyrolysis oil feedstock derived from pyrolysis of polymer waste, or a fraction thereof, and/or the polymer waste-based feedstock is or comprises a feedstock derived from hydrothermal liquefaction of polymer waste, or a fraction thereof.
7. The method according to any one of the preceding items, wherein the step (A) of providing the polymer waste-based feedstock includes a stage of thermal degradation (such as pyrolysis or hydrothermal liquefaction) of polymer waste.
8. The method according to any one of the preceding items, wherein the polymer waste-based feedstock provided in step (A) is a pyrolysis oil feedstock or a fraction thereof.
9. The method according to any one of the preceding items, wherein the polymer waste-based feedstock provided in step (A) is a liquefied and pre-treated material which has been subjected to pre-treatment after liquefaction.
10. The method according to any one of the preceding items, wherein the polymer waste-based feedstock provided in step (A) is or comprises a fraction of waste plastic pyrolysis oil.
11. The method according to any one of the preceding items, wherein the polymer waste-based feedstock provided in step (A) is or comprises a fraction of end-life tires pyrolysis oil (ELTPO).
12. The method according to any one of the preceding items, wherein the polymer waste-based feedstock provided in step (A) is a middle distillate range feedstock.
13. The method according to any one of the preceding items, wherein the polymer waste-based feedstock provided in step (A) is at least one of a diesel range fraction and a jet range fraction of a polymer waste-based material.
14. The method according to any one of the preceding items, wherein the polymer waste-based feedstock provided in step (A) is at least one of a diesel range fraction and a jet range fraction of a polymer waste-based oil.
15. The method according to any one of the preceding items, wherein the polymer waste-based feedstock provided in step (A) has a 5% boiling point of 110° C. or more, preferably 120° C. or more, 130° C. or more, or 135° C. or more.
16. The method according to any one of the preceding items, wherein the polymer waste-based feedstock provided in step (A) has an initial boiling point of 110° C. or more, preferably 120° C. or more, or 130° C. or more.
17. The method according to any one of the preceding items, wherein the polymer waste-based feedstock provided in step (A) has 95% boiling point of 400° C. or less, preferably 390° C. or less, 380° C. or less, 370° C. or less, 360° C. or less, or 350° C. or less.
18. The method according to any one of the preceding items, wherein the polymer waste-based feedstock provided in step (A) has final boiling point of 410° C. or less, preferably 400° C. or less, 390° C. or less, 380° C. or less, 370° C. or less, 360° C. or less, or 350° C. or less.
19. The method according to any one of the preceding items, wherein the polymer waste-based feedstock provided in step (A) has 95% boiling point of 320° C. or less, preferably 300° C. or less, 290° C. or less, 280° C. or less, 270° C. or less, or 260° C. or less.
20. The method according to any one of the preceding items, wherein the polymer waste-based feedstock provided in step (A) has final boiling point of 330° C. or less, preferably 320° C. or less, 300° C. or less, 290° C. or less, 280° C. or less, 270° C. or less, or 260° C. or less.
21. The method according to any one of the preceding items, wherein the polymer waste-based feedstock has a sulphur content of from 500 to 40000 mg/kg.
22. The method according to any one of the preceding items, wherein the polymer waste-based feedstock has an olefins content in the range of from 10 wt.-% to 85 wt.-%, such as 15 wt.-% to 80 wt.-%, 20 wt.-% to 70 wt.-%, 30 wt.-% to 65 wt.-% or 40 wt.-% to 65 wt.-%.
23. The method according to any one of the preceding items, wherein the polymer waste-based feedstock has an aromatics content in the range of from 10 wt.-% to 85 wt.-%, such as from 20 wt.-% to 80 wt.-%, 30 wt.-% to 80 wt.-%, 40 wt.-% to 70 wt.-% or 40 wt.-% to 60 wt.-%.
24. The method according to any one of the preceding items, wherein the hydrotreatment in step (D) is carried out at a temperature in the range of from 300-500° C.
25. The method according to any one of the preceding items, wherein the hydrotreatment is carried out at a temperature of 320° C. or more, preferably 330° C. or more, 340° C. or more, or 350° C. or more.
26. The method according to any one of the preceding items, wherein the hydrotreatment in step (D) is carried out at a temperature of 490° C. or less, preferably 480° C. or less, 470° C. or less, 460° C. or less, 450° C. or less, 450° C. or less, 440° C. or less, 430° C. or less, 420° C. or less, 410° C. or less, or 400° C. or less.
27. The method according to any one of the preceding items, wherein the hydrotreatment in step (D) is carried out at a hydrogen partial pressure of at least 20 bar, preferably at least 25 bar, at least 30 bar, at least 35 bar, or at least 40 bar.
28. The method according to any one of the preceding items, wherein the hydrotreatment in step (D) is carried out at a hydrogen partial pressure of at most 100 bar, preferably at most 90 bar, at most 80 bar, at most 70 bar, at most 60 bar, at most 55 bar, or at most 50 bar.
29. The method according to any one of the preceding items, wherein the hydrotreatment in step (D) is carried out in the presence of a catalyst and the catalyst is a supported catalyst.
30. The method according to any one of the preceding items, wherein the hydrotreatment in step (D) is carried out in the presence of a catalyst and the catalyst is a hydrodesulphurisation catalyst.
31. The method according to any one of the preceding items, wherein the hydrotreatment in step (D) is carried out in the presence of a catalyst and the catalyst comprises at least one component selected from IUPAC group 6, 8 or 10 of the Periodic Table of Elements.
32. The method according to any one of the preceding items, wherein the hydrotreatment in step (D) is carried out in the presence of a catalyst and the catalyst is a sulphided form of transition metal oxide(s).
33. The method according to any one of the preceding items, wherein the hydrotreatment in step (D) is carried out in the presence of a catalyst and the catalyst is a supported catalyst containing Mo and at least one further transition metal on a support.
34. The method according to any one of the preceding items, wherein the hydrotreatment in step (D) is carried out in the presence of a catalyst and the catalyst is a sulphided form of a NiMo catalyst and/or a CoMo catalyst.
35. The method according to any one of the preceding items, wherein the hydrotreatment in step (D) is carried out in the presence of a catalyst and the catalyst is a supported NiMo catalyst or a supported CoMo catalyst.
36. The method according to any one of the preceding items, wherein the hydrotreatment in step (D) is carried out in the presence of a catalyst and the catalyst is a supported catalyst, wherein the support comprises alumina and/or silica.
37. The method according to any one of the preceding items, wherein the hydrotreatment in step (D) is carried out in the presence of a catalyst and the catalyst is a supported NiMo catalyst and the support comprises alumina (NiMo/Al₂O₃).
38. The method according to any one of the preceding items, wherein the hydrotreatment in step (D) is carried out in the presence of a catalyst and the catalyst is a supported CoMo catalyst and the support comprises alumina (CoMo/Al₂O₃).
39. The method according to any one of the preceding items, wherein the blending in step (C) is carried out such that the feed mixture contains at most 50.0 wt.-% of the polymer waste-based feedstock, preferably at most 40.0 wt.-%, at most 30.0 wt.-%, or at most 25.0 wt.-%.
40. The method according to any one of the preceding items, wherein the blending in step (C) is carried out such that the feed mixture contains 0.5 wt.-% to 100.0 wt.-% of the polymer waste-based feedstock, preferably at least 1.0 wt.-%, at least 1.5 wt.-%, or at least 2.0 wt.-%, such as 1.0 wt.-% to 100.0 wt.-%, 1.0 wt.-% to 80.0 wt.-%, 1.5 wt.-% to 50.0 wt.-%, 2.0 wt.-% to 25.0 wt.-%, or 2.0 wt.-% to 15.0 wt.-%.
41. The method according to any one of the preceding items, wherein the blending in step (C) is carried out such that the feed mixture contains 25.0 wt.-% to 99.5 wt.-% of the crude oil-derived feedstock, preferably at least 30.0 wt.-%, at least 40.0 wt.-%, at least 50.0 wt.-%, at least 60.0 wt.-%, at least 70.0 wt.-% or at least 75.0 wt.-%, such as 50.0 wt.-% to 99.5 wt.-%, 70 wt.-% to 99.0 wt.-%, or 75.0 wt.-% to 95.0 wt.-%.
42. The method according to any one of the preceding items, wherein the polymer waste-based feedstock is or comprises a fraction of liquefied waste plastics (LWP), in particular a fraction of waste plastics pyrolysis oil (WPPO), or a fraction of end-life tires pyrolysis oil (ELTPO).
43. The method according to any one of the preceding items, wherein the polymer waste-based feedstock is or comprises a fraction of a pyrolysis oil feedstock derived from pyrolysis of polymer waste, and/or the polymer waste-based feedstock is or comprises a fraction of a feedstock derived from hydrothermal liquefaction of polymer waste.
44. The method according to any one of the preceding items, wherein the polymer waste-based feedstock is a fraction of a pyrolysis oil feedstock, preferably a fraction of end-life tires pyrolysis oil (ELTPO).
45. The method according to any one of the preceding items, wherein the polymer waste-based feedstock is a fraction of a liquefied and pre-treated material which has been subjected to pre-treatment and fractionation after liquefaction.
46. A jet fuel component obtainable by the method according to any of the items 1 to 45, wherein the jet fuel component has a final boiling point (FBP) in the range of from 190° C. to 300° C.
47. The jet fuel component according to item 46, wherein the jet fuel component has a cloud point in the range of from −60° C. to −120° C., such as −65° C. to −100° C., −70° C. to −95° C. or −72° C. to −90° C.
48. The jet fuel component according to item 46 or 47, wherein the jet fuel component has a kinematic viscosity at 20° C. in the range of from 1.20 mm²/s to 1.70 mm²/s, preferably form 1.25 mm²/s to 1.65 mm²/s, 1.25 mm²/s to 1.64 mm²/s, 1.30 mm²/s to 1.60 mm²/s, 1.30 mm²/s to 1.55 mm²/s.
49. The jet fuel component according to any one of items 46 to 48, wherein the jet fuel component has a kinematic viscosity at 40° C. in the range of from 1.00 mm²/s to 1.30 mm²/s, preferably form 1.00 mm²/s to 1.25 mm²/s, 1.00 mm²/s to 1.20 mm²/s, 1.05 mm²/s to 1.20 mm²/s, 1.05 mm²/s to 1.17 mm²/s.
50. The jet fuel component according to any one of items 46 to 49, wherein the jet fuel component has an initial boiling point (IBP) in the range of from 100° C. to 200° C., preferably from 120° C. to 180° C., 130° C. to 175° C., 140° C. to 170° C., or 150° C. to 170° C.
51. The jet fuel component according to any one of items 46 to 50, wherein the jet fuel component has a final boiling point (FBP) in the range of from 200° C. to 280° C., preferably from 200° C. to 260° C., 210° C. to 250° C., or 220° C. to 245° C.
52. The jet fuel component according to any one of items 46 to 51, wherein the jet fuel component has a 10 vol-% boiling point (DIS-10) in the range of from 130° C. to 210° C., preferably from 140° C. to 200° C., 150° C. to 190° C., 160° C. to 185° C., or 160° C. to 180° C.
53. The jet fuel component according to any one of items 46 to 52, wherein the jet fuel component has a 90 vol-% boiling point (DIS-90) in the range of from 180° C. to 290° C., preferably from 190° C. to 270° C., 200° C. to 260° C., 205° C. to 245° C., or 210° C. to 230° C.
54. The jet fuel component according to any one of items 46 to 53, wherein the jet fuel component has a total gum content measured in accordance with IP540 in the range of from 0.2 to 20.0, preferably from 0.5 to 15.0, 0.5 to 12.0, 0.5 to 10.0, 1.0 to 8.0, 1.5 to 6.0 or 2.0 to 4.0.
55. The jet fuel component according to any one of items 46 to 54, wherein the jet fuel component has a BOCLE lubricity in the range of from 0.60 mm to 0.85 mm, preferably from 0.65 mm to 0.85 mm, 0.70 mm to 0.85 mm, 0.73 mm to 0.85 mm, 0.74 mm to 0.82 mm, 0.75 mm to 0.80 mm or 0.75 mm to 0.78 mm.
56. The jet fuel component according to any one of items 46 to 55, wherein the jet fuel component has a sulphur content in the range of from 0 mg/kg to 3000 mg/kg, preferably from 0 mg/kg to 2000 mg/kg, 0 mg/kg to 1000 mg/kg, 0 mg/kg to 500 mg/kg, 0 mg/kg to 300 mg/kg, 0 mg/kg to 100 mg/kg, 0 mg/kg to 60 mg/kg, 0 mg/kg to 50 mg/kg, 0 mg/kg to 20 mg/kg, 0 mg/kg to 20 mg/kg, or 0 mg/kg to 10 mg/kg.
57. The jet fuel component according to item 46, wherein the jet fuel component has a freezing point in the range of from −55.0° C. to −99.0° C., such as −60.0° C. to −90.0° C., −61.0° C. to −80.0° C., −62.0° C. to −75.0° C., −62.0° C. to −70.0° C., or −63.0° C. to −69.0° C.
58. The jet fuel component according to item 46, wherein the jet fuel component has an aromatics content in the range of from 15.0 to 60.0 wt.-%, preferably from 16.0 wt.-% to 50.0 wt.-%, 17.0 wt.-% to 40.0 wt.-%, 18.0 wt.-% to 35.0 wt.-%, 19.0 wt.-% to 30.0 wt.-%, 20.0 wt.-% to 28.0 wt.-% 21.0 wt.-% to 27.0 wt.-%, 22.0 wt.-% to 27.0 wt.-%, or 23.0 wt.-% to 27.0 wt.-%.
59. A use of the jet fuel component according to any one of items 46 to 58 for producing a fuel.

### DETAILED DESCRIPTION OF THE INVENTION

The present invention relates to a method for upgrading polymer waste-based material and more specifically to a co-processing route for hydrotreating polymer waste-based material for producing jet fuel component(s).

A polymer waste-based material, such as a pyrolysis product of collected consumer plastics, industry plastics and/or end-life tires, contains large and varying amounts of contaminants which would be detrimental in downstream products or in downstream processes. Such contaminants include, among others, halogens (mainly chlorine) originating from halogenated plastics (such as PVC and PTFE), sulphur originating from cross-linking agents of rubbery polymers (e.g. in end-life tires) and metal (e.g. Si, Al) contaminants originating from composite materials and additives (e.g. films coated with metals or metal compounds, end-life tires, or plastics processing aids). These contaminants may be present in elemental form, in ionic form, or as a part of organic or inorganic compounds.

These impurities/contaminants may result in coking and/or other (undesired) side-reactions in conventional oil refinery methods (such as fractionation), thus shifting the product distribution to less valuable products or even towards products which have to be disposed (i.e. waste). Similarly, these impurities may have corrosive or otherwise degrading action, thus reducing the service life of the refinery equipment.

Moreover, the production process of polymer waste-based material comprises at least one kind of depolymerisation, usually by means of thermal degradation such as pyrolysis or hydrothermal liquefaction or similar process steps. It is intrinsic to these processes that the resulting polymer waste-based material has a high olefins content. The hydrodesulphurisation step (D) of the present invention reduces the content of at least sulphur impurities in the polymer waste-based material (and in the co-feed, as the case may be) and thus produces a hydrotreated material having (significantly) reduced content of sulphur. Surprisingly, the resulting jet fuel range product fraction shows properties which are superior even over pure fossil jet fuel (component).

The present invention relates to a method for upgrading polymer waste-based material, in particular a method for upgrading polymer waste-based material to produce a jet fuel component. The method of the present invention comprises the following steps:
(step A) providing a polymer waste-based feedstock,
(step B) providing a crude oil-derived feedstock,
(step C) blending the polymer waste-based feedstock, the crude oil-derived feedstock, and optionally a further feed material, to provide a feed mixture,
(step D) hydrotreating the feed mixture at hydrodesulphurisation conditions to provide a hydrotreated material boiling in the middle distillate range,
(step E) recovering at least a jet fuel component from the hydrotreated material.

The inventors surprisingly found that the feed mixture comprising the seemingly lower-quality polymer waste-based feedstock actually results in an improvement of the product properties. This is even more surprising when considering that the hydrotreating at hydrodesulphurisation conditions is a rather simple process. Specifically, this process preferably does not significantly influence the hydrocarbon species in the feed mixture, in particular does not lead to intended cracking or isomerisation. Despite this rather mild treatment, the resulting jet fuel (jet fuel component) shows improved properties, in particular improved cold properties, which are one of the main characteristics of jet fuel (also referred to as aviation fuel), since jet fuel is employed in airplanes, i.e. in high altitudes, and thus at very low temperatures.

Viscosity and lubricity are similarly improved when compared to hydrotreated crude oil-derived feedstock alone. Conventionally, jet fuel derived from crude oil-derived feedstock was not subjected to hydrodesulphurisation (HDS) because the sulphur levels in crude oil fractions are usually low enough to meet jet fuel specifications, such as 0.3 wt.-% or below. In addition, HDS was not employed because sulphur-containing compounds usually have lubricating properties and thus HDS would be thought to reduce the lubricity of the resulting jet fuel. Other than expected, the jet fuel (component) of the present invention provides improved lubricity even though it has is subjected to HDS.

The inventors furthermore found that the gum content is improved in the jet fuel (component) of the present invention. It is assumed that this improvement is also attributed to the combination of HDS with employing a blend of polymer waste-based feedstock and crude oil-derived feedstock.

In addition to improving the properties of the jet fuel component, the inventors found that blending the polymer waste-based feedstock results in improved yield. Thus, the method of the present invention makes use of a waste-derived material, intrinsically having rather high levels of impurities. In particular, end-life tires-based material, such as ELTPO, may have a high sulphur content in the range of one to several wt.-%. Nevertheless, the jet fuel (component) of the present invention even exceeds the characteristics of a comparable crude oil-based product.

In the present invention, the term “polymer waste” refers to an organic polymer material which is no longer fit for its use or which has been disposed for any other reason. Polymer waste may specifically be solid and/or liquid polymer material and is (or comprises) usually a solid polymer material. Polymer waste more specifically may refer to end-life tires, collected consumer plastics (consumer plastics referring to any organic polymer material in consumer good, even if not having “plastic” properties as such), collected industrial polymer waste. In the sense of the present invention, the term “polymer waste” or “polymer” in general does not encompass purely inorganic materials (which are otherwise sometimes referred to as inorganic polymers). Polymers in the polymer waste may be of natural and/or synthetic origin and may be based on renewable and/or fossil raw material.

The term “polymer waste-based feedstock” or “polymer waste-based material” refers to a feedstock (or raw material of a process) which is derived from polymer waste. In particular, “polymer waste-based feedstock” (or “polymer waste-based material”) specifically refers to an oil or an oil-like product obtainable from liquefaction, i.e. non-oxidative thermal or thermocatalytic depolymerisation of (solid) polymer waste (followed by optional subsequent fractionation and/or purification). In other words, the “polymer waste-based feedstock” or “polymer waste-based material” may also be referred to as “depolymerized polymer waste” or “liquefied polymer waste”. The depolymerisation preferably includes cleavage of carbon-carbon bonds.

The method of liquefaction is not particularly limited and one may mention pyrolysis (such as fast pyrolysis) of polymer waste, or hydrothermal liquefaction of polymer waste.

The term “hydrothermal liquefaction” (HTL) refers to a thermal depolymerization process to convert a carbon containing feedstock into crude-like oil under moderate temperature and high pressure. The term “pyrolysis” refers to thermal decomposition of materials at elevated temperatures in a non-oxidative atmosphere. The term “fast pyrolysis” refers to thermochemical decomposition of carbon containing feedstock through rapid heating in the absence of oxygen.

The term “crude oil-derived feedstock” refers to a material (or stream) which is derived from crude oil. Usually, the crude oil-derived feedstock will be a crude oil fraction, which may be further purified/polished or not. Preferably, a crude oil fraction which is not further purified or otherwise processed is employed as a crude oil-derived feedstock.

The term “feed mixture” refers to the mixture of at least the polymer waste-based feedstock and the crude oil-derived feedstock. The feed mixture may further contain one or more further feed material(s) other than a polymer waste-based feedstock and a crude oil-derived feedstock. In other words, the “further feed material” is neither a polymer waste-based feedstock nor a crude oil-derived feedstock. If two or more polymer waste-based materials (feedstocks) are employed in the feed mixture, these are collectively regarded as the polymer waste-based feedstock. Similarly, if two or more crude oil-derived materials (feedstocks) are employed in the feed mixture, these are collectively regarded as the crude oil-derived feedstock.

The term “hydrotreating” refers to a chemical transformation of the polymer waste-based feedstock in the presence of hydrogen to produce hydrotreated material. The hydrotreatment is carried out at hydrodesulphurisation conditions (under hydrodesulphurisation conditions). Hydrotreating the feed mixture at hydrodesulphurisation conditions may thus equivalently be referred to as subjecting the feed mixture to hydrodesulphurization (HDS). The hydrotreatment may be carried out in a hydrotreatment reactor which may be a batch-type reactor or a continuous-type reactor. The effluent of the hydrotreater will usually contain unreacted hydrogen, water, various gases and other compounds originating from heteroatoms or metals (such as H2S, HCl, HBr, NH3) and, as the case may be, non-reactive components such as carrier gas. Of these, at least gaseous components (and water) are preferably separated as a part of the hydrotreating process. The hydrotreatment (hydrotreating process) is carried out under hydrodesulphurisation conditions. In other words, the process is adapted such that hydrodesulphurisation is favoured over other reactions, specifically favoured over olefins and/or aromatics saturation reactions and over cracking reactions and isomerisation reactions, which may occur as (minor) side reactions, if any. Such a selectivity for hydrodesulphurisation may be achieved by appropriate selection of reaction conditions (such as catalyst type, reaction temperature and hydrogen partial pressure), which is familiar to the skilled person.

Specifically, although the invention is not intended to be limited to these, typical hydrodesulphurisation (HDS) reaction conditions comprise a LHSV 0.5-3.0 h⁻¹, preferably 0.7-2.0 h⁻¹, pressure 10-100 barg (gauge pressure), preferably 30-80 barg, operating temperature 320-450° C., preferably 340-400° C., and ratio between hydrogen (H₂) amount (e.g. flow rate) and feed amount (e.g. flow rate) (H₂/feed) in the range of 400-1000 dm³/dm³, and one or more hydrodesulphurisation catalysts. Exemplary non-limiting reaction conditions of step (D) comprise LSHV of about 0.8 h⁻¹, pressure of about 43 barg, temperature of about 360° C. and H₂/feed ratio of about 950 dm³/dm³.

The reaction is particularly preferably performed in the presence of one or more hydrodesulphurisation catalysts known in the art. Exemplary hydrodesulphurisation catalysts are selected from a group consisting of a NiMo-catalyst, CoMo-catalyst, NiW-catalyst and any mixtures thereof. Preferably the HDS catalyst is sulfided NiW, NiMo or CoMo catalyst.

Even though hydrodesulphurisation is favoured, at least hydrodeoxygenation may occur and olefins and aromates may at least partly be saturated and heteroatoms be removed. In other words, hydrotreating of step (D) is the reaction of organic compounds in the presence of hydrogen to remove at least sulphur as H2S, optionally further removing other heteroatoms (such as O, N, P) and/or altering the degree of saturation of the organic compounds. The resulting material (after separation of gaseous compounds, water, heteroatom-derived material and metal-derived material) consists predominantly of hydrocarbons (molecules consisting of hydrogen atoms and carbon atoms) and may contain residual (non-hydrocarbon) impurities.

The term “hydrotreated material” refers to a material which predominantly consists of hydrocarbons (i.e. molecules consisting of carbon and hydrogen atoms). Specifically, the “hydrotreated material” preferably contains at least 95.0 wt.-% of carbon (C) and hydrogen (H) atoms, as determined by elemental analysis, relative to the material as a whole. Other components such as oxygen (O), sulphur (S), nitrogen (N) may be present as well, usually in the form of organic molecules. The content of H and C is preferably at least 97.0 wt.-%, at least 98.0 wt.-% or at least 99.0 wt.-%.

The term “distilling” refers to a separation method by evaporation and condensation and encompasses fractionation. Distilling may be carried out under elevated pressure, under ambient pressure and/or under reduced pressure. The result of the distillation (distilling process) is at least one distillate (fraction) and a distillation residue (or distillation bottoms, i.e. the heaviest fraction). Accordingly, the recovery of step € may be carried out as a distillation. Usually, distillation is carried out as fractionation and results in multiple distillate fractions having differing boiling point ranges. These distillate fractions are usually mixtures of multiple compounds and are usually designated by their starting boiling point and by the end boiling point, such as 160° C.-290° C., usually meaning that the fraction starts boiling at or above 160° C. and is fully evaporated at or below 290° C. The distillation bottoms fraction is usually designated only by its initial boiling point (or starting boiling point) and is recovered without being distilled or evaporated (i.e. from the bottom of the distillation).

The present invention is based on the finding that co-processing of a polymer waste-based feedstock and a crude-oil derived feedstock at hydrodesulphurisation conditions is possible and allows preparing a higher-value (upgraded) material from the otherwise difficult to handle polymer waste-based feedstock. Specifically, the co-processing under these specific conditions allows integration of the highly diverse and thus difficult polymer waste-based feedstock into conventional petrochemical processes with small effort and costs, eventually providing a favourably upgraded material ready for use as a jet fuel component.

Specifically, the co-processing allows easy integration of varying amounts of recycled material (polymer waste or polymer waste-based material). By design, even a conventional hydrodesulphurisation reactor is suited to handle difficult feeds, such as a crude oil fraction having very high sulphur content, and thus can handle the (highly contaminated) polymer waste-based feedstock as well.

In addition, when employing a liquefied polymer waste, not only the jet fuel component (jet fuel fraction) is obtained in improved yield but furthermore valuable higher-boiling fractions may be obtained (and fractionated and recovered), such as a gas oil fraction, a heavy gas oil fraction or a vacuum gas oil fraction.

Preferably, the crude oil-derived feedstock is a middle distillate range feedstock. Using such as kind of feedstock helps improving the yield of jet fuel component and facilitates recovering the jet fuel component.

Specifically, the crude oil-derived feedstock may be at least one crude oil fraction selected from a kerosene fraction, a light gas oil fraction and a gas oil fraction.

In the context of the present invention, a middle distillate fraction preferably has a boiling range (from initial boiling point, IBP, to final boiling point, FBP) in the range of from 100° C. to 410° C., more preferably of from 110° C. to 390° C., 120° C. to 380° C., 120° C. to 370° C., 120° C.-360° C., 120° C. to 350° C. or 130° C. to 350° C. A middle distillate fraction in accordance with the present invention preferably has 5%-95% boiling range (from 5% boiling point to 95% boiling point according to ASTM-D7345) in the range of from 110° C. to 400° C., more preferably of from 110° C. to 390° C., 120° C. to 380° C., 120° C. to 370° C., 120° C.-360° C., 130° C. to 350° C. or 135° C. to 350° C.

In the present invention, the “final boiling point” (FBP) refers to the 99.5% boiling point and the “initial boiling point” (IBP) refers to the 0.5% boiling point (according to ASTM-D7345).

In the context of the present invention, a diesel range fraction preferably has a 5% boiling point (5 wt.-% boiling point according to ASTM-D7345) of at least 140° C., preferably at least 150° C., at least, 160° C. or at least 170° C. A diesel range fraction in accordance with the present invention preferably has 95% boiling point (95 wt.-% boiling point according to ASTM-D7345) of 400° C. or less, preferably 390° C. or less, 380° C. or less, 370° C. or less, 360° C. or less, or 350° C. or less.

In the context of the present invention, a jet range fraction preferably has a 5% boiling point (5 wt.-% boiling point according to ASTM-D7345) of at least 140° C., preferably at least 150° C., at least 160° C. or at least 170° C. A jet range fraction in accordance with the present invention preferably has 95% boiling point (95 wt.-% boiling point according to ASTM-D7345) of 320° C. or less, preferably 300° C. or less, 290° C. or less, 280° C. or less, 270° C. or less, 260° C. or less, 250° C. or less, 250° C. or less 240 C or less or 230° C. or less. Thus the 5-95% boiling range may preferably be 140-320° C., such as 150-290° C.

Preferably, the polymer waste-based feedstock provided in step (A) is or comprises a polymer waste-based oil or a fraction thereof, preferably a fraction of polymer waste-based oil. That is, a polymer waste-based oil (such as a liquefied polymer waste) may be used without being fractionated (full boiling range). Preferably, the polymer waste-based feedstock is, however, a fraction (specifically a middle distillate fraction) of polymer waste-based oil. This allows further improving the yield and, in particular, quality of the resulting jet fuel component. On the other hand, employing a full boiling point range (i.e. non-fractionated) polymer waste-based oil may be favourable in particular of the method shall be tailored to producing mainly a heavier fraction (in addition to the jet fuel fraction or component). Thus, the method of the present invention provides a broad range of possible product distribution and can contribute to increasing sustainability of petrochemical processes in general.

The polymer waste-based feedstock provided in step (A) is or comprises liquefied waste plastics (LWP) or a fraction thereof, in particular waste plastics pyrolysis oil (WPPO) or a fraction thereof, or end-life tires pyrolysis oil (ELTPO) or a fraction thereof. It is particularly preferred that the polymer waste-based feedstock is or comprises a fraction of liquefied waste plastics (LWP), in particular a fraction of waste plastics pyrolysis oil (WPPO), or a fraction of end-life tires pyrolysis oil (ELTPO).

It is particularly preferred that the polymer waste-based feedstock provided in step (A) is or comprises a pyrolysis oil feedstock derived from pyrolysis of polymer waste, or a fraction thereof, and/or the polymer waste-based feedstock is or comprises a feedstock derived from hydrothermal liquefaction of polymer waste, or a fraction thereof. Specifically, it is preferred that the polymer waste-based feedstock is or comprises a fraction of a pyrolysis oil feedstock derived from pyrolysis of polymer waste, and/or the polymer waste-based feedstock is or comprises a fraction of a feedstock derived from hydrothermal liquefaction of polymer waste.

Preferably, the polymer waste-based feedstock provided in step (A) is or comprises a fraction of waste plastic pyrolysis oil and/or the polymer waste-based feedstock provided in step (A) is or comprises a fraction of end-life tires pyrolysis oil (ELTPO).

In particular, the polymer waste-based feedstock provided in step (A) may be a pyrolysis oil feedstock or a fraction thereof. Specifically, the polymer waste-based feedstock may be a fraction of a pyrolysis oil feedstock, preferably a fraction of end-life tires pyrolysis oil (ELTPO).

In general, the polymer waste-based feedstock provided in step (A) may be a liquefied and pre-treated material which has been subjected to pre-treatment after liquefaction. In particular, the polymer waste-based feedstock may be a fraction of a liquefied and pre-treated material which has been subjected to pre-treatment and fractionation after liquefaction.

The step (A) of providing the polymer waste-based feedstock may include a stage of thermal degradation (such as pyrolysis or hydrothermal liquefaction) of polymer waste. Thus, a complete method can be provided from (solid) polymer waste to upgraded material. The thermal degradation step may further comprise a work-up stage, such as a separation stage.

The polymer waste-based feedstock provided in step (A) may a middle distillate range feedstock. This embodiment allows further improving yield and/or quality of the resulting jet fuel component. The polymer waste-based feedstock provided in step (A) may be at least one of a diesel range fraction and a jet range fraction of a polymer waste-based material, e.g. at least one of a diesel range fraction and a jet range fraction of a polymer waste-based oil.

The polymer waste-based feedstock provided in step (A) may have a 5% boiling point of 110° C. or more, preferably 120° C. or more, 130° C. or more, or 135° C. or more. The polymer waste-based feedstock provided in step (A) may have an initial boiling point of 110° C. or more, preferably 120° C. or more, or 130° C. or more. The polymer waste-based feedstock provided in step (A) may have 95% boiling point of 400° C. or less, preferably 390° C. or less, 380° C. or less, 370° C. or less, 360° C. or less, or 350° C. or less. Further, the polymer waste-based feedstock provided in step (A) may have final boiling point of 410° C. or less, preferably 400° C. or less, 390° C. or less, 380° C. or less, 370° C. or less, 360° C. or less, or 350° C. or less. In a more narrow concept, the polymer waste-based feedstock provided in step (A) may have 95% boiling point of 320° C. or less, preferably 300° C. or less, 290° C. or less, 280° C. or less, 270° C. or less, or 260° C. or less, and/or a final boiling point of 330° C. or less, preferably 320° C. or less, 300° C. or less, 290° C. or less, 280° C. or less, 270° C. or less, or 260° C. or less. The boiling point (or boiling range) of the polymer waste-based feedstock may be adjusted in accordance with need, especially it may be adapted to be similar to the boiling point of the crude coil-based feedstock in order to facilitate processing in the hydrotreatment step (D). The boiling point of the polymer waste-based feedstock is, however, not decisive. Rather, it may be favourable to employ a fractionation after the hydrotreatment and thus adjusting the boiling point (or boiling range) of the polymer waste-based feedstock may be dispensed with.

The polymer waste-based feedstock may have a sulphur content of from 500 to 40000 mg/kg. Such a high sulphur content may in particular be obtained when the polymer waste-based feedstock is at least partially derived from end-life tires, e.g. when the polymer waste-based feedstock is or comprises ELTPO. The sulphur content may be determined by ASTM D6667M.

The polymer waste-based feedstock may have an olefins content of in the range of from 10 wt.-% to 85 wt.-%, such as 15 wt.-% to 80 wt.-%, 20 wt.-% to 70 wt.-%, 30 wt.-% to 65 wt.-% or 40 wt.-% to 65 wt.-%. The polymer waste-based feedstock may have an aromatics content of in the range of from 10 wt.-% to 85 wt.-%, such as from 20 wt.-% to 80 wt.-%, 30 wt.-% to 80 wt.-%, 40 wt.-% to 70 wt.-% or 40 wt.-% to 60 wt.-%.

Preferably, the hydrotreatment in step (D) is carried out at a temperature in the range of from 300-500° C., preferably 320-450° C., more preferably 340-400° C. Specifically, the hydrotreatment may be carried out at a temperature of 320° C. or more, preferably 330° C. or more, 340° C. or more, or 350° C. or more and/or at a temperature of 490° C. or less, preferably 480° C. or less, 470° C. or less, 460° C. or less, 450° C. or less, 450° C. or less, 440° C. or less, 430° C. or less, 420° C. or less, 410° C. or less, or 400° C. or less.

For example, the hydrotreatment in step (D) may be carried out at a hydrogen partial pressure of at least 20 bar, preferably at least 25 bar, at least 30 bar, at least 35 bar, or at least 40 bar. Furthermore, the hydrotreatment in step (D) may be carried out at a hydrogen partial pressure of at most 100 bar, preferably at most 90 bar, at most 80 bar, at most 70 bar, at most 60 bar, at most 55 bar, or at most 50 bar. In particular, an upper limit of the hydrogen partial pressure, as indicated above, is favourable in order to ensure that the hydrotreatment reaction favours hydrodesulphurisation over e.g. olefin saturation or hydrocracking. If not specified to the contrary, a pressure value given in the present invention refers to absolute pressure.

The hydrotreatment in step (D) may be carried out at liquid hourly space velocity (LHSV, m³ liquid feed per m³ catalyst per hour) in the range of 0.3-5.0 h⁻¹, preferably 0.5-2.0 h⁻¹, more preferably 0.7-1.2 h⁻¹.

The hydrotreatment may be carried out in a single stage. That is, a single stage hydrotreatment is usually sufficient to achieve hydrodesulphurization. Other procedures such as hydrocracking usually require multi-stage processes and in most cases harsher conditions.

The hydrotreatment in step (D) is preferably carried out in the presence of a catalyst. The catalyst may be a supported catalyst. Employing a catalyst facilitates ensuring efficient hydrotreatment and helps reducing isomerisation tendency and/or cracking tendency. Particularly, the preferred catalysts specified below facilitate reducing isomerisation tendency and/or cracking tendency. Appropriate selection of a catalyst favouring hydrodesulphurisation over other reactions, in particular hydrocracking, hydroisomerisation or hydrodearomatisation, and preferably also over olefin saturation lies within the skilled person's common knowledge.

In one embodiment a part of the HDS product, i.e. the hydrotreated material comprising at least a fraction boiling in the middle distillate range, may be circulated back to the hydrotreatment (or upstream), wherein the ratio of fresh feed to circulated feed is 10:1 or less. The fresh feed refer to all non-circulated feed, comprising at least the blend of polymer waste-based feedstock and crude oil-derived feedstock.

In one embodiment there is no circulation of HDS product. Compared to HDO, reaction temperature in HDS is easier to control due to less exothermic reactions taking place, thus no circulation of HDS product is needed for cooling. Specifically, the oxygen content of ELTPO is low so that no or few deoxygenation reactions take place.

Particularly preferably, the catalyst is a hydrodesulphurisation catalyst. For example, the catalyst may comprise at least one component selected from IUPAC group 6, 8 or 10 of the Periodic Table of Elements. The catalyst is preferably a sulphided form of transition metal oxide(s). Specifically, the catalyst according to the present invention is preferably employed as sulphided catalysts to ensure that the catalyst is in its active (sulphided) form. Turning catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the beginning or a sulphur additive may be admixed to the feed.

Specifically, the catalyst may be a supported catalyst containing Mo and at least one further transition metal on a support. Examples of such a supported catalyst are a supported NiMo catalyst or a supported CoMo catalyst, or a mixture of both. As said above, the transition metal based catalysts mentioned in the present specification are preferably employed in their sulphided form. In a supported catalyst, the support preferably comprises alumina and/or silica.

In general, when employing a supported catalyst, the support preferably comprises alumina and/or silica. The catalyst may be a supported NiMo catalyst and the support comprises alumina (NiMo/Al₂O₃) or a supported CoMo catalyst and the support comprises alumina (CoMo/Al₂O₃), or a combination of both.

The blending in step (C) is preferably carried out such that the feed mixture contains at most 50.0 wt.-% of the polymer waste-based feedstock, preferably at most 40.0 wt.-%, at most 30.0 wt.-%, or at most 25.0 wt.-%. In other words, the mixing in step (C) is preferably adjusted such that the feed mixture contains at most 50.0 wt.-% of the polymer waste-based feedstock, preferably at most 40.0 wt.-%, at most 30.0 wt.-% or at most 25.0 wt.-%. This adjustment may suitably be achieved by simply blending the desired amount.

In general, the blending (step C) may be carried out in a separate vessel or feed line before the hydrotreatment or the blending may be carried out within the hydrotreatment reactor. Preferably, the polymer waste-based feedstock and the crude oil-derived feedstock are blended before entering the hydrotreatment reactor, for example in a pre-heater unit.

The content ranges of the polymer waste-based feedstock as mentioned above have shown to give good results in the final product. The present invention thus covers a significant blending range up to high contents of polymer waste-based feedstock. In other words, due to feature combination of the present invention, the method of the present invention is suited for a broad content range of polymer waste-based feedstock in the feed mixture subjected to hydrotreatment. The content of the polymer waste-based feedstock is preferably not higher than 50.0 wt.-% in order to ensure easy integration into existing processes.

In order to ensure at least some use of recycled material (polymer waste-based feedstock) and thus sustainability, the feed mixture contains at least 0.5 wt.-% of the polymer waste-based feedstock, preferably at least 1.0 wt.-%, at least 1.5 wt.-% or at least 2.0 wt.-%. In other words, the blending in step (C) is adjusted such that the feed mixture contains at least 0.5 wt.-% of the polymer waste-based feedstock, preferably at least 1.0 wt.-%, at least 1.5 wt.-% or at least 2.0 wt.-%.

Preferably, the feed mixture contains at least 25.0 wt.-% of the crude oil-derived feedstock, preferably at least 30.0 wt.-%, at least 40.0 wt.-%, at least 50.0 wt.-%, at least 60.0 wt.-%, at least 70.0 wt.-% or at least 75.0 wt.-%. In other words, the blending in step (C) is preferably adjusted such that the feed mixture contains at least 25.0 wt.-% of the crude oil-derived feedstock, preferably at least 30.0 wt.-%, at least 40.0 wt.-%, at least 50.0 wt.-%, at least 60.0 wt.-%, at least 70.0 wt.-% or at least 75.0 wt.-%.

In the present invention, any range generated by an upper limit, including preferred upper limit(s), and a lower limit, including preferred lower limit(s), may be combined to provide a preferred range(s) for working the invention.

A minimum content of crude oil-derived feedstock, which is a conventional feedstock in hydrotreatment in petrochemical processes, ensures that the method of the present invention can be easily integrated into existing petrochemical processes. Nevertheless, a high degree of sustainability can be achieved, if desired.

The present invention further provides a jet fuel component obtainable by the method according to the present invention. In addition to a jet fuel component (or jet fuel fraction), other fraction(s), in particular higher boiling fraction(s) may be recovered as well. In this case, the method may comprise a least one distillation (or evaporation or fractionation) stage as a part of the recovery step.

The jet fuel component preferably has a cloud point in the range of from −60° C. to −120° C., such as in the range from −65° C. to −100° C., −70° C. to −95° C., or −72° C. to −90° C.

Preferably, the jet fuel component has a kinematic viscosity at 20° C. in the range of from 1.20 mm²/s to 1.70 mm²/s, preferably form 1.25 mm²/s to 1.65 mm²/s, 1.25 mm²/s to 1.64 mm²/s, 1.30 mm²/s to 1.60 mm²/s, 1.30 mm²/s to 1.55 mm²/s.

The jet fuel component preferably has a kinematic viscosity at 40° C. in the range of from 1.00 mm²/s to 1.30 mm²/s, more preferably form 1.00 mm²/s to 1.25 mm²/s, 1.00 mm²/s to 1.20 mm²/s, 1.05 mm²/s to 1.20 mm²/s, 1.05 mm²/s to 1.17 mm²/s.

The jet fuel component preferably has an initial boiling point (IBP) in the range of from 100° C. to 200° C., more preferably from 120° C. to 180° C., 130° C. to 175° C., 140° C. to 170° C., or 150° C. to 170° C.

The jet fuel component has a final boiling point (FBP) in the range of from 190° C. to 300° C., more preferably from 200° C. to 280° C., 200° C. to 260° C., 210° C. to 250° C., or 220° C. to 245° C.

The jet fuel component preferably has a 10 vol-% boiling point (DIS-10) in the range of from 130° C. to 210° C., more preferably from 140° C. to 200° C., 150° C. to 190° C., 160° C. to 185° C., or 160° C. to 180° C.

The jet fuel component preferably has a 90 vol-% boiling point (DIS-90) in the range of from 180° C. to 290° C., more preferably from 190° C. to 270° C., 200° C. to 260° C., 205° C. to 245° C., or 210° C. to 230° C.

Preferably, the jet fuel component has a total gum content measured in accordance with IP540 in the range of from 0.2 to 20.0, more preferably from 0.5 to 15.0, 0.5 to 12.0, 0.5 to 10.0, 1.0 to 8.0, 1.5 to 6.0 or 2.0 to 4.0.

The jet fuel component preferably has a BOCLE lubricity in the range of from 0.60 mm to 0.85 mm, more preferably from 0.65 mm to 0.85 mm, 0.70 mm to 0.85 mm, 0.73 mm to 0.85 mm, 0.74 mm to 0.82 mm, 0.75 mm to 0.80 mm or 0.75 mm to 0.78 mm.

Preferably, the jet fuel component has a sulphur content in the range of from 0 mg/kg to 3000 mg/kg, more preferably from 0 mg/kg to 2000 mg/kg, 0 mg/kg to 1000 mg/kg, 0 mg/kg to 500 mg/kg, 0 mg/kg to 300 mg/kg, 0 mg/kg to 100 mg/kg, 0 mg/kg to 60 mg/kg, 0 mg/kg to 50 mg/kg, 0 mg/kg to 20 mg/kg, 0 mg/kg to 20 mg/kg, or 0 mg/kg to 10 mg/kg.

The jet fuel component preferably has a freezing point in the range of from −55.0° C. to −99.0° C., such as −60.0° C. to −90.0° C., −61.0° C. to −80.0° C., −62.0° C. to −75.0° C., −62.0° C. to −70.0° C., or −63.0° C. to −69.0° C.

The jet fuel component preferably has an aromatics content in the range of from 15.0 to 60.0 wt.-%, more preferably from 16.0 wt.-% to 50.0 wt.-%, 17.0 wt.-% to 40.0 wt.-%, 18.0 wt.-% to 35.0 wt.-%, 19.0 wt.-% to 30.0 wt.-%, 20.0 wt.-% to 28.0 wt.-% 21.0 wt.-% to 27.0 wt.-%, 22.0 wt.-% to 27.0 wt.-%, or 23.0 wt.-% to 27.0 wt.-%.

Preferably, the method of the present invention is adapted such that a jet fuel component having one or more of the above-mentioned properties is produced. This may be achieved by appropriately selecting the relative content of polymer waste-based feedstock, hydrotreatment conditions and/or distillation range(s)/boiling range(s) of the respective fractions and/or of the jet fuel component.

The present invention further provides a use of the jet fuel component for producing a fuel, in particular a jet fuel.

The present invention has been described with reference to specific embodiments. Unless specified to the contrary each of these preferred embodiments and each of the ranges of numerical values (of any degree of preference) may be combined with any other embodiment and/or any other ranges of numerical values (of any degree of preference) and each of these combinations shall be encompassed within the disclosure of the present invention.

### Measurement Methods Used in the Present Invention

Unless specified otherwise, the following measurement methods can be applied in the present invention.

In the present invention, the content of F, CI, and Br may be determined in accordance with ASTM-D7359. The content of iodine (I) may be determined by XFS (X-ray fluorescence spectroscopy). Nitrogen (N) content may be determined in accordance with ASTM-D5762 (for nitrogen contents of 40 mg/kg or higher, preferably at least 80 mg/kg) or in accordance with ASTM-D4629 (for nitrogen contents ranging from 0.3 to 100 mg/kg, preferably less than 80 mg/kg). Aromatics content may be determined according to EN12916.

For methods not mentioned above, the methods used in the Examples may be employed. In the context of the present invention, standards (e.g. ASTM or EN-ISO) refer to the latest version available on Nov. 30, 2020, unless specified otherwise.

### EXAMPLES

In the following, the present invention will be described by reference to Examples. It is to be understood that Examples are for illustration purposes and shall not limit the scope of the invention, which is defined by the claims. Nevertheless, numerical values and ranges (of e.g. contents of compounds or impurities) disclosed in the Examples may be combined with numerical values and/or ranges disclosed in the general description above to give new numerical ranges.

### Example 1

A diesel fraction of ELTPO (end-life tires pyrolysis oil) was prepared by pyrolysis of end-life tires, followed by fractionation and employed as a polymer waste-based feedstock without further purification. This polymer waste-based feedstock had a sulphur content (ASTM D7039) of 0.82 wt.-%. A conventional crude oil-derived diesel range fraction was used as a crude oil-derived feedstock. A feed mixture was prepared by blending the ELTPO fraction and the fossil feed such that the total content of ELTPO fraction in the feed mixture was 10 wt.-% and the total content of the fossil feed in the feed mixture was 90 wt.-%. Blending was achieved by feeding two separate streams into the continuous-type HDS reactor at respective flow rates corresponding to the weight ratio, i.e. at a flow rate ratio of 1:9.

The feed mixture was thus subjected to hydrotreatment in a HDS hydrotreater. Hydrotreatment conditions were set to 398° C. and 43 bar hydrogen partial pressure (with no added inert gas), 0.83 h⁻¹ LHSV,

After the hydrotreatment, the liquid product was recovered by gas-liquid separation and the total liquid product was distilled to two different fractions, namely jet fraction (IBP-240° C.) and a heavy fraction (240° C.-FBP). The product properties are shown in Tables 1 and 2. The catalyst (CoMo/Al₂O₃) of the hydrotreater was sulphided at the start of the experiment.

### Comparative Example 1

The hydrotreatment and distillation of Example 1 was repeated, except for using 100% of the fossil feedstock as a reference sample. The results are shown in Tables 1 and 2.

TABLE 1
Boiling properties of jet fuel component
according to ASTM D7345

| | Example 1 | Comp.-Example 1 |
|---|---|---|
| Property | Temperature [° C.] | Temperature [° C.] |
| IBP | 164.1 | 171.4 |
| DIS-10 | 173.9 | 181.3 |
| DIS-50 | 189.2 | 196.8 |
| DIS-90 | 213.2 | 219.6 |
| FBP | 229.9 | 238.9 |

TABLE 2
Detailed analysis of jet fuel fraction

| Property | Method | Example 1 | | Comp.-Ex. 1 | |
|---|---|---|---|---|---|
| Density | EN ISO 12185 | 805.7 | kg/m3 | 803.6 | kg/m3 |
| Colour | ASTM D6045 | 29 | | >30 | |
| Cloud point | ASTM D7689 | −76° | C. | −64° | C. |
| Viscosity (20° C.) | EN ISO 3104 | 1.483 | mm2/s | 1.649 | mm2/s |
| Viscosity (40° C.) | EN ISO 3104 | 1.128 | mm2/s | 1.230 | mm2/s |
| Cu corrosion (2 h/100° C.) | EN ISO 2160 | 1b | | 1a | |
| Smoke point | ASTM D1322 | 21.4 | mm | 23.0 | mm |
| Acidity | ASTM D3242 | 0.006 | mg KOH/g | 0.001 | mg KOH/g |
| Total Aromatics | EN 12916 | 24.8 | wt.-% | 21.7 | wt.-% |
| Nitrogen | ASTM D4629 | 0.3 | mg/l | 0.4 | mg/l |
| Sulphur | ASTM D7039 | <2 | mg/kg | 3 | mg/kg |
| Freezing point | IP529 | −66.3° | C. | −60.7° | C. |
| Total gum | IP540 | 3 mg/100 ml | | 16 mg/100 ml | |
| BOCLE | ASTM D5001 | 0.76 | mm | 0.79 | mm |

As can be seen from the above data, combining a polymer waste-based material with a conventional fossil (crude oil-based) material surprisingly not only increases the share of jet fuel range fraction but furthermore significantly improves the almost all properties thereof, while one would rather expect that the waste-based material deteriorates the properties of the resulting high-value product. The significant improvement of properties is even more surprising in view of the fact that only a minor amount (10 wt.-%) of ELTPO fraction was used.

1. A method for upgrading polymer waste-based material, the method comprising:
providing a polymer waste-based feedstock including liquefied waste plastic (LWP) or a fraction thereof and/or end-life-tires pyrolysis oil (ELTPO) or a fraction thereof (step A);
providing a crude oil-derived feedstock (step B);
blending the polymer waste-based feedstock, the crude oil-derived feedstock, and optionally a further feed material, to provide a feed mixture (step C), wherein the blending in step (C) is carried out such that the feed mixture contains at least 0.5 wt.-% of the polymer waste-based feedstock;
hydrotreating the feed mixture at hydrodesulphurisation conditions to provide a hydrotreated material (step D); and
distilling the hydrotreated material (step E) to obtain at least a jet fuel component having a final boiling point (FBP) in a range of from 190° C. to 300° C. and a residue fraction.

2. The method according to claim 1, wherein the polymer waste-based feedstock provided in step (A) is or comprises:
a polymer waste-based oil or a fraction thereof, and/or a fraction of polymer waste-based oil.

3. The method according to claim 1, wherein the polymer waste-based feedstock provided in step (A) is or comprises:
liquefied waste plastics (LWP) or a fraction thereof, and/or waste plastics pyrolysis oil (WPPO) or a fraction thereof, and/or end-life tires pyrolysis oil (ELTPO) or a fraction thereof.

4. The method according to claim 1, comprising:
subjecting the polymer waste-based feedstock provided in step (A) to pre-treatment after liquefaction.

5. The method according to claim 1, wherein the polymer waste-based feedstock provided in step (A) is or comprises:
a fraction of end-life tires pyrolysis oil (ELTPO).

6. The method according to claim 1, wherein the polymer waste-based feedstock provided in step (A) is a middle distillate range feedstock.

7. The method according to claim 1, comprising:
carrying out the hydrotreatment in step (D) at a hydrogen partial pressure of at most 100 bar, and/or at most 90 bar, and/or at most 80 bar, and/or at most 70 bar, and/or at most 60 bar, and/or at most 55 bar, and/or at most 50 bar.

8. The method according to claim 1, comprising:
carrying out the hydrotreatment in step (D) in a presence of a catalyst and the catalyst is a hydrodesulphurisation catalyst.

9. The method according to claim 1, comprising:
carrying out the blending in step (C) such that the feed mixture contains at most 50.0 wt.-% of the polymer waste-based feedstock, and/or at most 40.0 wt.-%, and/or at most 30.0 wt.-%, and/or at most 25.0 wt.-%.

10. The method according to claim 1, wherein the polymer waste-based feedstock is or comprises:
fraction of liquefied waste plastics (LWP), and/or a fraction of waste plastics pyrolysis oil (WPPO), and/or a fraction of end-life tires pyrolysis oil (ELTPO).

11. The method according to claim 1, wherein the polymer waste-based feedstock has a sulphur content of from 500 to 40000 mg/kg.

12. A jet fuel component obtained by the method according to claim 1, wherein the jet fuel component has a final boiling point (FBP) in a range of from 190° C. to 300° C.

13. The jet fuel component according to claim 12, wherein the jet fuel component has a sulphur content in the range of from 0 mg/kg to 3000 mg/kg, and/or from 0 mg/kg to 2000 mg/kg, and/or 0 mg/kg to 1000 mg/kg, and/or 0 mg/kg to 500 mg/kg, and/or 0 mg/kg to 300 mg/kg, and/or 0 mg/kg to 100 mg/kg, and/or 0 mg/kg to 60 mg/kg, and/or 0 mg/kg to 50 mg/kg, and/or 0 mg/kg to 20 mg/kg, and/or 0 mg/kg to 20 mg/kg, and/or 0 mg/kg to 10 mg/kg.

14. The jet fuel component according to claim 12, wherein the jet fuel component has a total gum content measured in accordance with IP540 in a range of from 0.2 to 20.0, and/or from 0.5 to 15.0, 0.5 to 12.0, 0.5 to 10.0, 1.0 to 8.0, 1.5 to 6.0 and/or 2.0 to 4.0.

15. A method according to claim 1, comprising:
producing a fuel with the jet fuel component, wherein the jet fuel component has a final boiling point (FBP) in a range of from 190° C. to 300° C.

16. The method according to claim 2, wherein the polymer waste-based feedstock provided in step (A) is or comprises:
liquefied waste plastics (LWP) or a fraction thereof, and/or waste plastics pyrolysis oil (WPPO) or a fraction thereof, and/or end-life tires pyrolysis oil (ELTPO) or a fraction thereof.

17. The method according to claim 16, comprising:
subjecting the polymer waste-based feedstock provided in step (A) to pre-treatment after liquefaction.

18. The method according to claim 17, wherein the polymer waste-based feedstock provided in step (A) is or comprises:
a fraction of end-life tires pyrolysis oil (ELTPO).

19. The method according to claim 18, wherein the polymer waste-based feedstock provided in step (A) is a middle distillate range feedstock.

20. A jet fuel component obtained by the method according to claim 19, wherein the jet fuel component has a final boiling point (FBP) in a range of from 190° C. to 300° C.
